(19) United States
(12) Patent Application Publication
(10) Pub. No.: US 2020/0004481 A1
(43) Pub. Date: Jan. 2, 2020

(54) IMAGE PROCESSING APPARATUS AND NON-TRANSITORY COMPUTER READABLE MEDIUM

(71) Applicant: FUJI XEROX CO., LTD., Tokyo (JP)

(72) Inventors: Shinsuke TSUDA, Kanagawa (JP); Takuya OTA, Kanagawa (JP)

(73) Assignee: FUJI XEROX CO., LTD., Tokyo (JP)

(21) Appl. No.: 16/445,232

(22) Filed: Jun. 19, 2019

(30) Foreign Application Priority Data
Jun. 28, 2018 (JP) 2018-122727

(51) Int. Cl. G06F 3/12; G06T 7/00

(52) U.S. Cl. CPC G06F 3/1256; G06T 2207/30168; G06T 7/0002; G06F 3/1208

(57) ABSTRACT

An image processing apparatus includes a processor and a warning unit. The processor applies screen processing to image data including a periodic pattern. The warning unit outputs, in a case where a difference between an evaluation value of image quality of the image data before the screen processing and an evaluation value of image quality of the image data after the screen processing is outside a predetermined range of values, warning information indicating that the difference is outside the predetermined range of values.

### CROSS-REFERENCE TO RELATED APPLICATIONS

This application is based on and claims priority under 35 USC 119 from Japanese Patent Application No. 2018-122727 filed Jun. 28, 2018.

### BACKGROUND

### (i) Technical Field

The present disclosure relates to an image processing apparatus and a non-transitory computer readable medium.

### (ii) Related Art

In recent years, there has been proposed an image forming apparatus for determining whether or not moiré is caused by interference between a document and a screen (for example, see Japanese Unexamined Patent Application Publication No. 2007-129558).

The image forming apparatus described in Japanese Unexamined Patent Application Publication No. 2007-129558 is an image forming apparatus including an image processor that generates printable image data by applying certain image processing to an input image. The image forming apparatus includes a moiré determining unit that determines, before the image data is output, the occurrence of moiré caused by interference between the input image and a screen, and a halftone processing switching unit that switches a halftone processing method in accordance with the occurrence of moiré. The moiré determining unit calculates a moiré frequency from the frequency of a document image and the frequency of the screen, and, in the case where the lowest moiré frequency among moiré frequencies is less than a certain value, warns a user of the occurrence of moiré that the output image has a striking moiré pattern.

### SUMMARY

Aspects of non-limiting embodiments of the present disclosure relate to providing an image processing apparatus and a non-transitory computer readable medium storing a program for suppressing printing whose image quality is deteriorated by interference between a periodic pattern included in image data and a periodic pattern used in screen processing for reproducing halftone with the use of an image output apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing apparatus including a processor and a warning unit. The processor applies screen processing to image data including a periodic pattern. The warning unit outputs, in a case where a difference between an evaluation value of image quality of the image data before the screen processing and an evaluation value of image quality of the image data after the screen processing is outside a predetermined range of values, warning information indicating that the difference is outside the predetermined range of values.

### BRIEF DESCRIPTION OF THE DRAWINGS

An exemplary embodiment of the present disclosure will be described in detail based on the following figures, wherein:

FIG. 1 is a block diagram illustrating an example of the configuration of an image processing system according to an exemplary embodiment of the present disclosure;

FIG. 2 is a diagram illustrating an example of a setting screen regarding warnings;

FIG. 3 is a diagram illustrating an example of a setting screen regarding the image quality;

FIGS. 4A and 4B are diagrams each illustrating an example of a screen pattern;

FIGS. 5A to 5C are diagrams illustrating examples in which the reproducibility of the output result is deteriorated by screen processing; and

FIG. 6 is a flowchart illustrating an example of the operation of the image processing system according to the exemplary embodiment.

### DETAILED DESCRIPTION

Hereinafter, an exemplary embodiment of the present disclosure will be described with reference to the drawings. Elements in the drawings that have substantially the same function are given the same reference numeral in the drawings, and overlapping descriptions are omitted.

### SUMMARY OF EXEMPLARY EMBODIMENT

An image processing apparatus according to the exemplary embodiment includes a processor that applies screen processing to image data including a periodic pattern, and a warning unit that outputs, in the case where the difference between the evaluation value of the image quality of the image data before the screen processing and the evaluation value of the image quality of the image data after the screen processing is outside a predetermined range of values, warning information indicating that the difference is outside the predetermined range of values.

The term “periodic pattern” refers to a pattern in which a matrix (not limited to a rectangular shape) composed of a plurality of pixels (dots) is periodically arranged, and corresponds to, for example, a houndstooth pattern, a dither pattern used to represent pseudo-halftone, and the like.

The term “screen processing” refers to processing that reproduces pseudo-halftone using image data (such as binary image data) whose number of gradations is less than the original image data. In screen processing, an m×n-pixel pattern composed of a plurality of dots (hereinafter may also be referred to as a “screen pattern”) is used. Screen patterns include, for example, a line type (may also be referred to as a parallel-line screen) that represents pseudo-halftone by changing the width of lines arranged at a specific interval (may also be referred to as the number of lines), and a dot type that represents pseudo-halftone by changing the size of dots whose centers are arranged at a specific interval.

### EXEMPLARY EMBODIMENT

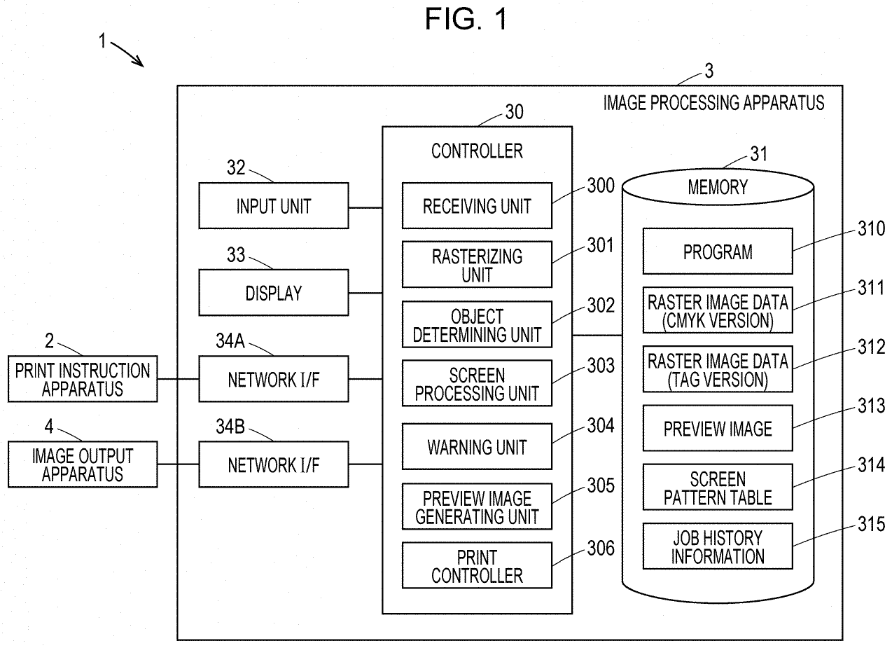

FIG. 1 is a block diagram illustrating an example of the configuration of an image processing system according to the exemplary embodiment of the present disclosure. An image processing system 1 includes a print instruction apparatus 2, an image processing apparatus 3, and an image output apparatus 4. The print instruction apparatus 2 and the image output apparatus 4 may be provided in plural. For example, a server apparatus with the function of a print server corresponds to the image processing apparatus 3.

The print instruction apparatus 2 includes, for example, a personal computer, a tablet terminal, and a mobile information terminal such as a multi-functional mobile phone (smartphone). The print instruction apparatus 2 is configured to transmit a print job to the image processing apparatus 3. A print job is an example of print instruction information that gives a print instruction.

A print job includes a job identification (ID) that identifies the print job, print data described in a page description language (PDL) that the image processing apparatus 3 and the image output apparatus 4 are able to analyze, and attribute information indicating print attributes such as various print conditions including double sided/single sided printing, the number of copies, and so forth.

PDLs include, for example, Portable Document Format (PDF), PostScript (registered trademark), and Printer Command Language (PCL).

Print data includes multi-tone data such as photographs, and furthermore may include a periodic pattern representing a decoration line, a ruled line, a pattern, or the like. Furthermore, an image representing halftone using a dither matrix or the like may include a periodic pattern. In contrast, in the case where the image output apparatus 4 is not compatible with multi-tone data, multi-tone data is subjected to screen processing by the image processing apparatus 3 and is output to the image output apparatus 4.

As the image output apparatus 4, for example, a printer that forms an image on a recording medium such as paper using electrophotographic printing or inkjet printing, or a multinational peripheral with a plurality of functions such as scanning, printing, copying, and fax may be used. In the exemplary embodiment, a printer that forms a color image or a monochrome image using toners of the following colors, namely, yellow (Y), cyan (C), magenta (M), and black (K), is used.

### Configuration of Image Processing Apparatus

The image processing apparatus 3 includes a controller 30, which controls the units of the image processing apparatus 3; memory 31, which stores various types of information; an input unit 32, which is realized by a keyboard, a mouse, and the like; a display 33, which is realized by a liquid crystal display (LCD) or the like; a network interface (I/F) 34A, which communicates with the print instruction apparatus 2; and a network I/F 34B, which communicates with the image output apparatus 4.

The controller 30 includes a central processing unit (CPU), an interface, and the like. By operating in accordance with a program 310 stored in the memory 31, the CPU functions as a receiving unit 300, a rasterizing unit 301, an object determining unit 302, a screen processing unit 303, a warning unit 304, a preview image generating unit 305, a print controller 306, and so forth. The rasterizing unit 301 is an example of a generating unit. The screen processing unit 303 is an example of a processor. These units 300 to 306 will be described later.

The memory 31 includes read-only memory (ROM), random-access memory (RAM), a hard disk, and the like. The memory 31 stores various types of information such as the program 310, CMYK-version raster image data 311, TAG-version raster image data 312, a preview image 313, a screen pattern table 314, job history information 315, and the like. In the screen pattern table 314, information on a screen pattern is recorded in association with a screen pattern ID for identifying the screen pattern. The job history information 315 is an example of history information.

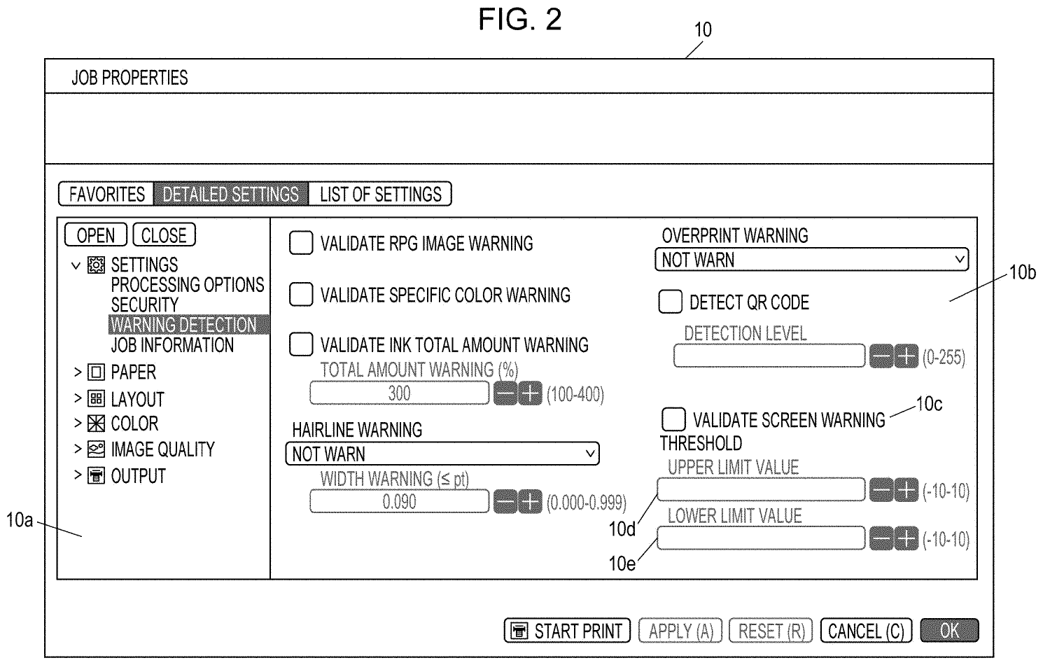

FIG. 2 is a diagram illustrating an example of a setting screen regarding warnings. A setting screen 10 indicates a state in which the tab “detailed settings” is selected from among the tabs “favorites”, “detailed settings”, and “list of settings”, and the item “warning/detection” belonging to “settings” displayed on a menu area 10a is selected. An item 10c “validate screen warning”, displayed on a work area 10b, is selected; an upper limit value (plus sign) Th1 is input in an input field 10d for the upper limit value of a threshold for a difference ΔDm between the average values of pixel values (hereinafter may also be referred to as “pixel average values”) of pixels constituting a later-described specific object before and after screen processing; a lower limit value (minus sign) Th2 is input in an input field 10e for the lower limit value; and a warning regarding a screen is set. The pixel average values are examples of the evaluation values of the image quality. The upper limit value Th1 and the lower limit value Th2 of the threshold are an example of a predetermined range of values. The difference ΔDm between the pixel average values, and the threshold upper limit value Th1 and lower limit value Th2 will be described later.

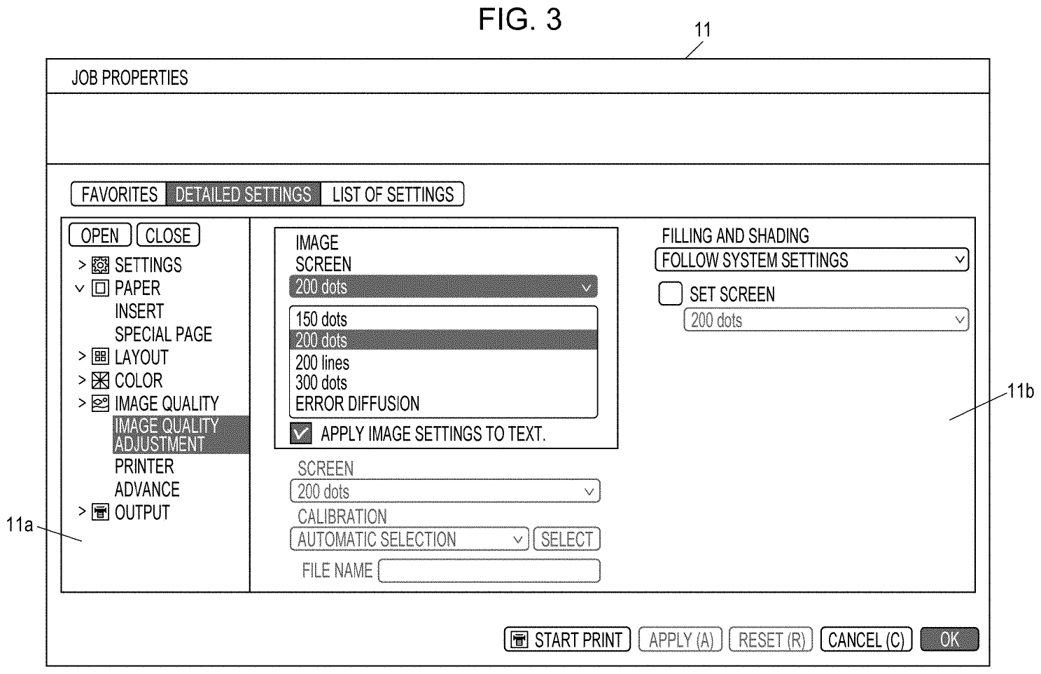

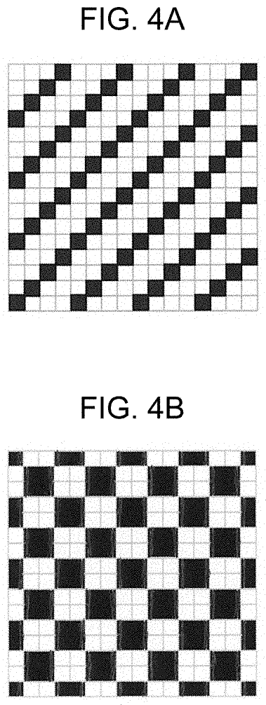

FIG. 3 is a diagram illustrating an example of a setting screen regarding the image quality. A setting screen 11 indicates a state in which the tab “detailed settings” is selected from among the tabs “favorites”, “detailed settings”, and “list of settings”, and the item “image quality adjustment” belonging to “image quality” displayed on a menu area 11a is selected. As screen patterns, 150 dots, 200 dots, and 300 dots are prepared as dot types (see FIG. 4B), and 200 lines is prepared as a line type (see FIG. 4A). In addition, error diffusion is prepared as a method for representing halftone without having the number of screen lines or a screen angle. These are recorded in the screen pattern table 314. FIG. 3 illustrates a state in which 200 dots is selected as a dot-type screen pattern.

FIGS. 4A and 4B are diagrams each illustrating a type of screen pattern recorded in the screen pattern table 314. FIG. 4A illustrates an example of a line-type screen pattern, and FIG. 4B illustrates an example of a dot-type screen pattern.

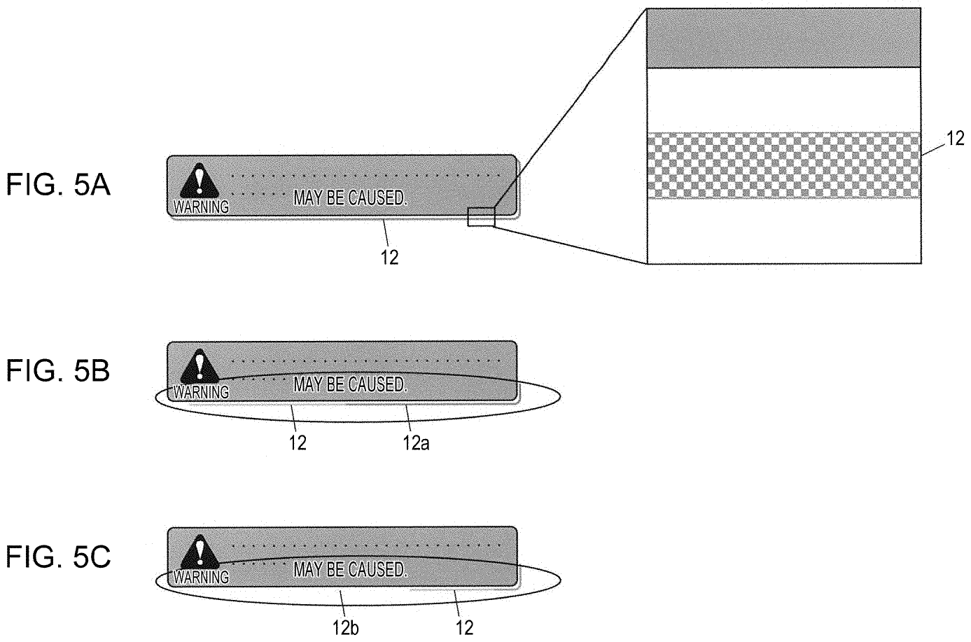

A periodic pattern in image data may interfere with a screen pattern used in screen processing to cause deterioration of the image quality, such as moiré or density unevenness. Image quality deterioration caused by interference includes, for example, a defect 12a in which the number of dots representing a decoration line 12 increases and the decoration line 12 looks dark or thick (see FIG. 5B), and a defect 12b in which the number of dots representing the decoration line 12 decreases and the decoration line 12 looks pale or thin or seems as if it disappears (see FIG. 5C). These will be described with reference to FIGS. 5A to 5C.

FIGS. 5A to 5C are diagrams illustrating examples in which the reproducibility of the output result is deteriorated by screen processing. FIG. 5A illustrates a major part of the CMYK-version raster image data 311 before performing screen processing. As illustrated in the enlarged view, the decoration line 12 is formed using a lattice pattern. FIG. 5B illustrates the defect 12a, in which the number of dots in part of the decoration line 12 increases and the decoration line 12 looks dark or thick in the case of where the raster image data 311 illustrated in FIG. 5A is subjected to screen processing using the 200-dot dot-type screen pattern. FIG. 5C illustrates the defect 12b, in which the number of dots in part of the decoration line 12 decreases and the decoration line 12 looks pale or seems as if it disappears in the case where the raster image data 311 illustrated in FIG. 5A is subjected to screen processing using the 200-dot dot-type screen pattern.

The defect 12a of the decoration line 12 illustrated in FIG. 5B is a phenomenon that appears in the case where the difference ΔDm between the pixel average values before the screen processing and after the screen processing is greater than the threshold upper limit value Th1. The defect 12b of the decoration line 12 illustrated in FIG. 5C is a phenomenon that appears in the case where the difference ΔDm between the pixel average values before the screen processing and after the screen processing is less than the threshold lower limit value Th2. Depending on the settings of the threshold upper limit value Th1 and lower limit value Th2, there may be a case in which the defects 12a and 12b illustrated in FIGS. 5B and 5C do not appear but moiré appears in the raster image data 311 after the screen processing even in the case where the difference ΔDm between the pixel average values is within the upper limit value Th1 and the lower limit value Th2 (including ΔDm=Th1 or Th2), and there may also be another case in which none of the defects 12a and 12b illustrated in FIGS. 5B and 5C and moiré appears in the raster image data 311 after the screen processing.

### Description of Each Unit

Next, the units 300 to 306 of the controller 30 will be described.

The receiving unit 300 receives a print job transmitted from the print instruction apparatus 2. Attribute information included in the print job may include information indicating whether to validate or invalidate an output of warning information. In addition, the attribute information included in the print job may include the setting details of screen processing. In addition, the receiving unit 300 receives operations on various setting screens, such as the settings screens 10 and 11.

The rasterizing unit 301 generates raster image data by rasterizing print data included in the print job. The raster image data is generated in accordance with the attribute information and is bitmap image data constituted of a set of points in units of dots (pixels). Specifically, the rasterizing unit 301 generates CMYK-version raster image data 311 corresponding to the individual CMYK colors, and also generates TAG-version raster image data 312. The CMYK-version raster image data 311 is constituted of raster image data of each version of CMYK. The CMYK-version raster image data 311 is an example of image data.

The TAG-version raster image data 312 is, for example, image data that includes, for each pixel, an object ID (tag information) indicating the type of object. The TAG-version raster image data 312 included in the print data does not always have the same resolution as the raster image data of each version of CMYK. Here, resolution conversion is performed to match the resolution of the TAG-version raster image data 312 with the raster image data of each version of CMYK.

The TAG-version raster image data 312 is generated in an output format such as Joint Photographic Experts Group (JPEG), Graphics Interchange Format (GIF), or Portable Network Graphics (PNG).

The object determining unit 302 analyzes the type of object on the basis of the TAG-version raster image data 312, and determines whether the type of object is a specific object. Upon determining that the type of object is a specific object, the object determining unit 302 outputs the determination result to the screen processing unit 303 and the warning unit 304.

Regarding one or more specific objects, for example, types that are namely a text object, a stroke object, a fill object, and a shade object are not regarded as specific objects, and an image object is regarded as a specific object. In addition, among image objects, types that include file extension data indicating lossless-compressed data, such as gif, png, zip, may be regarded as specific objects. Because interference occurs more easily in lossless-compressed data than in lossy-compressed data such as jpeg, narrowing down further the image objects may enable processing at higher speed than in the case where the warning unit 304 processes all the image objects.

The screen processing unit 303 generates image data by applying screen processing to the entire CMYK-version raster image data 311 using a screen pattern set on the setting screen 11 illustrated in FIG. 3. In addition, in the case where the attribute information of the print job includes the setting details of screen processing, the screen processing unit 303 may perform screen processing while giving a high priority to the setting details of screen processing on the print job side. In addition, in the case of performing screen processing in accordance with the warning settings, the screen processing unit 303 performs screen processing of a specific object included in the CMYK-version raster image data 311 in accordance with the determination result from the object determining unit 302, using a screen pattern set on the setting screen 11 illustrated in FIG. 3.

In the case where the difference between the evaluation value of the image quality of the CMYK-version raster image data 311 before the screen processing and the evaluation value of the image quality of the CMYK-version raster image data 311 after the screen processing is outside a predetermined range of values, the warning unit 304 outputs warning information indicating that the difference is outside the predetermined range of values. Specifically, the warning unit 304 calculates the difference ΔDm between Dmb and Dma using the following equation (1)

ΔDm=Dma−Dmb (1)

where Dmb denotes the pixel average value before the screen processing and Dma denotes the pixel average value after the screen processing.

In the case where this difference ΔDm is outside the range between the threshold upper limit value Th1 and lower limit value Th2, set on the setting screen 10, the warning unit 304 outputs warning information indicating that difference ΔDm is outside the range.

The pixel average value is calculated by dividing the sum of the pixel values of pixels constituting a specific object by the number of the pixels constituting the specific object. In the case of the defect 12a illustrated in FIG. 5B, the difference ΔDm has a plus sign. In the case of the defect 12b illustrated in FIG. 5C, the difference ΔDm has a minus sign.

In the case of outputting warning information, the warning unit 304 may, for example, display the warning information by including the warning information in a preview image 313 generated by the preview image generating unit 305, or may control the image output apparatus 4 to print and output the warning information by including the warning information in the CMYK-version raster image data 311. Specifically, a specific object in the preview image 313 is rendered using a specific color (may also be referred to as a warning color), and the preview image 313 including the specific object is displayed on the display 33. In addition, control is applied to render a specific object in the CMYK-version raster image data 311 using a specific color and to print the CMYK-version raster image data 311 including the specific object. Accordingly, the user may be notified that the image quality may be deteriorated and which object's image quality may be deteriorated.

A specific color may be determined in accordance with an output target. For the preview image 313, a striking color such as red is desired. In the case of a printed matter, a metal color (gold, silver, etc.), a non-metal color (transparent, white, colored, etc.), or a warm color (red, orange, yellow, etc.) serving as a striking color may be used. Alternatively, the preview image 313 may be highlighted by causing the preview image 313 to flicker or by displaying an animation of the preview image 313. Alternatively, as warning information to be included in the preview image 313 or the CMYK-version raster image data 311, any information (such as text, a symbol, a figure, a tag, an arrow, a mark, a contour line, etc.) that is decoratively added may be displayed, or a message such as “The image object's image quality may deteriorate” may be displayed.

In addition to the above, the warning unit 304 may record the warning information as part of the job history information 315. The warning information to be recorded as part of the job history information 315 includes, for example, information indicating that the image quality may deteriorate, a job ID or a page including an object whose image quality may deteriorate, and the location (coordinates) and the size of the object.

In the case where the attribute information of the print job includes information indicating whether to validate or invalidate an output of warning information, the warning unit 304 follows that information.

On the basis of the CMYK-version raster image data 311, the preview image generating unit 305 generates a preview image 313 and records the preview image 313 in the memory 31. The preview image 313 is, for example, an image obtained by decreasing the resolution of the CMYK-version raster image data 311.

In the case where the warning unit 304 does not output warning information, the print controller 306 controls the image output apparatus 4 to print image data generated by performing, by the screen processing unit 303, screen processing of the entire CMYK-version raster image data 311. Even in the case where the warning unit 304 outputs warning information, in response to a print instruction given by a user on a checking screen displayed on the display 33, the print controller 306 may control the image output apparatus 4 to print the screen-processed image data.

### Operation in Exemplary Embodiment

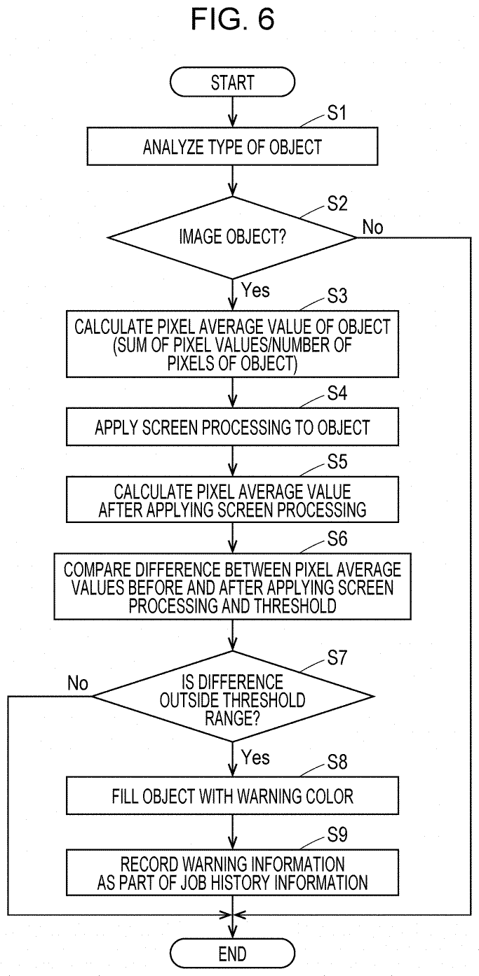

Next, an example of the operation of the image processing system 1 will be described with reference to FIG. 6. FIG. 6 is a flowchart illustrating an example of the operation of the image processing system 1.

When the receiving unit 300 of the image processing apparatus 3 receives a print job transmitted from the print instruction apparatus 2, the rasterizing unit 301 rasterizes print data which is PDL data included in the print job to generate CMYK-version raster image data 311, and also generates TAG-version raster image data 312. The rasterizing unit 301 stores the CMYK-version raster image data 311 and the TAG-version raster image data 312 in the memory 31.

The object determining unit 302 analyzes the type of object on the basis of the TAG-version raster image data 312 (S1), and determines whether the type of object is an image object (S2). Upon determining that the type of object is an image object (yes in S2), the object determining unit 302 outputs the determination result to the screen processing unit 303 and the warning unit 304.

In the case where the object is determined to be an image object (yes in S2), the warning unit 304 calculates the pixel average value Dmb of the image object before screen processing on the basis of the object determination result from the object determining unit 302 (S3).

On the basis of the object determination result from the object determining unit 302, the screen processing unit 303 applies screen processing to the image object included in the CMYK-version raster image data 311 (S4).

For the CMYK-version raster image data 311 after the screen processing, like step S3, the warning unit 304 calculates the pixel average value Dma of the image object after the screen processing (S5).

The warning unit 304 compares the pixel average value Dmb before the screen processing and the pixel average value Dma after the screen processing (S6), and determines whether the difference ΔDm between the two pixel average values is outside the range between the threshold upper limit value Th1 and lower limit value Th2 (S7).

In the case where the difference is outside the range (yes in S7), the warning unit 304 fills the image object included in a preview image 313 generated by the preview image generating unit 305 with a warning color, and displays the preview image 313 including the image object on the display 33 (S8). The warning unit 304 records the warning information as part of the job history information 315 (S9).

Although the exemplary embodiment of the present disclosure has been described above, the exemplary embodiment of the present disclosure is not limited to the above-described exemplary embodiment, and various modifications and implementations may be made within a scope not changing the gist of the present disclosure. For example, in the case where the warning unit 304 has output the warning information, the warning unit 304 may also display the setting screen 11 regarding the screen along with a message such as “Do you want to change the screen pattern?” to prompt the user to change the screen pattern, and may evaluate the image quality again. In addition, the present disclosure is applicable to an image forming apparatus including the image output apparatus 4.

Some (one or more) or all of the units of the controller 30 may be set up by a hardware circuit such as a field-programmable gate array (FPGA) or an application-specific integrated circuit (ASIC).

In addition, some (one or more) of the elements of the above-described exemplary embodiment may be omitted or changed within a scope not changing the gist of the present disclosure. In addition, one or more steps may be added, deleted, changed, or replaced in the flow of the exemplary embodiment within a scope not changing the gist of the present disclosure. In addition, a program used in the above-described exemplary embodiment may be recorded on a computer-readable recoding medium such as a compact-disc read-only memory (CD-ROM) and provided, or may be stored in an external server such as a cloud server and used via a network.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image processing apparatus comprising:
a processor that applies screen processing to image data including a periodic pattern; and
a warning unit that outputs, in a case where a difference between an evaluation value of image quality of the image data before the screen processing and an evaluation value of image quality of the image data after the screen processing is outside a predetermined range of values, warning information indicating that the difference is outside the predetermined range of values.

2. The image processing apparatus according to claim 1, wherein the warning unit calculates the evaluation values regarding a specific object.

3. The image processing apparatus according to claim 2, wherein, in a case where a difference between an average value of pixel values of pixels constituting the specific object before the screen processing and an average value of pixel values of pixels constituting the specific object after the screen processing is outside a predetermined range of values, the warning unit outputs the warning information.

4. The image processing apparatus according to claim 2, wherein the specific object is an image object.

5. The image processing apparatus according to claim 4, wherein the image object is composed of lossless-compressed data.

6. The image processing apparatus according to claim 1, wherein the warning unit displays the warning information by including the warning information in a preview image of the corresponding image data.

7. The image processing apparatus according to claim 1, wherein the warning unit applies control to print and output the warning information on a recording medium by including the warning information in the corresponding image data.

8. The image processing apparatus according to claim 6, wherein the warning information is rendering the specific object using a specific color.

9. The image processing apparatus according to claim 6, wherein the warning unit further records the warning information as history information.

10. The image processing apparatus according to claim 1, further comprising:
a receiving unit that receives print instruction information including print data; and
a generating unit that generates the image data from the print data,
wherein, in a case where the print instruction information includes setting details of the screen processing, the processor performs the screen processing while giving a high priority to the setting details of the screen processing.

11. The image processing apparatus according to claim 1, further comprising:
a receiving unit that receives print instruction information including print data; and
a generating unit that generates the image data from the print data, wherein:
the print instruction information includes information indicating whether to validate or invalidate an output of the warning information, and
the warning unit follows the information.

12. A non-transitory computer readable medium storing a program causing a computer to execute a process, the process comprising:
applying screen processing to image data including a periodic pattern; and
in a case where a difference between an evaluation value of image quality of the image data before the screen processing and an evaluation value of image quality of the image data after the screen processing is outside a predetermined range of values, outputting warning information indicating that the difference is outside the predetermined range of values.

13. An image processing apparatus comprising:
processing means for applying screen processing to image data including a periodic pattern; and
warning means for outputting, in a case where a difference between an evaluation value of image quality of the image data before the screen processing and an evaluation value of image quality of the image data after the screen processing is outside a predetermined range of values, warning information indicating that the difference is outside the predetermined range of values.
